(19) United States
(12) Patent Application Publication
(10) Pub. No.: US 2013/0128802 A1
(43) Pub. Date: May 23, 2013

(54) MULTI-RELAY TRANSMISSION APPARATUS AND METHOD USING INTERFERENCE ALIGNMENT

(71) Applicants: Joun Sup PARK, Suwon (KR); Young Chai Ko, Seoul (KR); Seong Ho Park, Seoul (KR)

(72) Inventors: Joun Sup PARK, Suwon (KR); Young Chai Ko, Seoul (KR); Seong Ho Park, Seoul (KR)

(73) Assignee: SAMSUNG ELECTRO-MECHANICS CO., LTD. Korea University Research & Business Foundation

(21) Appl. No.: 13/364,083

(22) Filed: Feb. 1, 2012

(30) Foreign Application Priority Data
Nov. 21, 2011 (KR) 10-2011-0121833

(51) Int. Cl. H04B 15/00; H04W 88/04

(52) U.S. Cl. 370/315

(57) ABSTRACT

There are provided a multi-relay transmission apparatus and method. The multi-relay transmission apparatus includes: a source node repeatedly alternately performing a first phase in which preceding data is transmitted during a first transmission period equivalent to a transmission period during which unit frames are transmitted and a second phase in which subsequent data that follows the preceding data is transmitted during a second transmission period that follows the first transmission period; and a relay network including a plurality of relay nodes receiving data from the source node, in which, in the first phase, a predetermined relay node, among the plurality of relay nodes, receives the preceding data from the source node and the remaining relay nodes, among the plurality of relay nodes, and in the second phase, the remaining relay nodes receive the subsequent data from the source node.

### CROSS-REFERENCE TO RELATED APPLICATIONS

This application claims the priority of Korean Patent Application No. 10-2011-0121833 filed on Nov. 21, 2011, in the Korean Intellectual Property Office, the disclosure of which is incorporated herein by reference.

### BACKGROUND OF THE INVENTION

1. Field of the Invention

The present invention relates to a multi-relay transmission apparatus and method of using an interference alignment scheme capable of minimizing a reduction in the degree of freedom made in canceling interference by using the interference alignment scheme to obtain a high data transfer rate in comparison to an existing relay transmission method.

2. Description of the Related Art

In general, a relay may be used to solve a communication problem between a base station and a terminal in a wireless communication system. The use of a relay enhances communications reliability and frequency efficiency and extends base station coverage, allowing for high speed data transmissions.

Due to such advantages, relay technology is currently a core technology in fourth-generation communication standards such as IEEE 802.16j, IEEE 802.16m, mm-wave-based WPAN, IEEE 802.11VHT wireless LAN, 3GPP LTE-Advanced, and the like.

Meanwhile, in an actual relay environment, uni-directional communications (a half-duplex relay scheme), rather than bi-directional communications (a full-duplex relay scheme), have been considered due to problems in system implementation, complexity, and the like. However, uni-directional communications involve a problem in which frequency efficiency is halved, which leads to a reduction in the pre-log factor (or the degree of freedom) of a total transfer rate.

Here, in order to solve the problem of the reduction in the pre-log factor, a scheme of using multiple relays may be considered. In this case, however, signals between or among multiple relays may act as interference signals, so a technique of effectively controlling interference signals is required.

Existing uni-directional communications use a scheme of transmitting a signal from a source node to a destination node by using a half-duplex relay, and have a problem in which frequency efficiency is halved due to the use of the half-duplex relay.

Namely, unlike a scheme in which a source node directly transfers a signal to a destination node, the half-duplex relay scheme has degraded frequency efficiency because a signal is transmitted through a relay.

For example, in a multi-relay system including a single source node, a plurality of relays, and a single destination node, when opportunistic relaying (a selective half-duplex relay scheme) is employed, a relay having the best channel environment is selected from among the plurality of relay nodes between the source node and the relays and between the relays and the destination node.

However, in the existing multi-relay system, even with the selective relay scheme, the problem in which the degree of freedom of a total data transfer rate is degraded remains unsolved.

### SUMMARY OF THE INVENTION

An aspect of the present invention provides a multi-relay transmission apparatus and method capable of minimizing a reduction in the degree of freedom of a data transfer rate by using an interference alignment scheme when a base station (source node) transmits data to a terminal (destination node) by way of multiple relay nodes, and capable of allowing the base station to continuously transmit data to the terminal in alternate stages of first and second phases through a plurality of relays to the terminal, in a multi-relay system including a single source node, a single destination node, and a plurality of half-duplex relay nodes.

According to an aspect of the present invention, there is provided a multi-relay transmission apparatus including: a source node repeatedly alternately performing a first phase in which preceding data is transmitted during a first transmission period equivalent to a transmission period during which unit frames are transmitted and a second phase in which subsequent data that follows the preceding data is transmitted during a second transmission period that follows the first transmission period; and a relay network including a plurality of relay nodes receiving data from the source node, in which, in the first phase, a predetermined relay node, among the plurality of relay nodes, receives the preceding data from the source node and the remaining relay nodes, among the plurality of relay nodes, transmit previous data ahead of the preceding data to a destination node, and in the second phase, the remaining relay nodes receive the subsequent data from the source node and the predetermined relay node transmits the preceding data to the destination node.

In the first phase, the remaining relay nodes may transmit a precoded interference signal generated by applying a pre-set interference removal scheme to the previous data of the preceding data, to the predetermined relay node.

In the second phase, the predetermined relay node may transmit a precoded interference signal generated by applying the pre-set interference removal scheme to the preceding data, to the remaining relay nodes.

In the second phase, the source node may transmit the precoded interference signal generated by applying the pre-set interference removal scheme to the subsequent data, to the remaining relay nodes.

In the first phase, the predetermined relay node may receive the precoded interference signal from the remaining relay nodes and cancel the received precoded interference signal by using the pre-set interference removal scheme.

In the second phase, the remaining relay nodes may receive the precoded interference signal from the predetermined relay node and cancel the received precoded interference signal by using the pre-set interference removal scheme.

The relay network may include first, second, and third relay nodes, and the precoded interference signal may be obtained by using precoding matrices VD1 and VD2 that follow an interference alignment scheme in the first phase, wherein the precoding matrices VD1 and VD2 can be expressed by Equation 1 and Equation 2 shown below:

span(H31*VD1)=span(H32*VD2) [Equation 1]

VD1=(H31)⁻¹H32*VD2,

VD2=(H32)⁻¹H31*VD1 [Equation 2]

wherein H31 is a channel from the first relay node to the third relay node, VD1 is a precoding matrix from the second relay node to the destination node, H32 is a channel from the second relay node to the third relay node, and VD2 is a precoding matrix from the second relay node to the destination node.

The precoded interference signal may be obtained by using precoding matrices V2S, V1S, and VD3 that follow the interference alignment scheme in the second phase, and the precoding matrixes V2S, V1S, and VD3 can be expressed by Equation 3 and Equation 4 shown below:

span(H1S*V2S)=span(H13*VD3),

span(H2S*V1S)=span(H23*VD3), [Equation 3]

V2S=(H1S)⁻¹H13*VD3,

V1S=(H2S)⁻¹H23*VD3

VD3=(H13)⁻¹H13*V2S

VD3=(H23)⁻¹H2S*V1S [Equation 4]

wherein H1S is a channel from the source node to the first relay node, V2S is a precoding matrix from the source node to the second relay node, H2S is a channel from the source node to the second relay node, V1S is a precoding matrix from the source node to the first relay node, H13 is a channel from the third relay node to the first relay node, VD3 is a precoding matrix from the third relay node to the destination node, H23 is a channel from the third relay node to the second relay node, and VD3 is a precoding matrix from the third relay node to the destination node.

According to another aspect of the present invention, there is provided a multi-relay transmission method including: a determination step of determining whether a source node has data to be transmitted; a first phase performing step of performing a first phase of transmitting preceding data during a first transmission period equivalent to a transmission period during which unit frames are transmitted, when the source node has data to be transmitted, wherein, in the first phase, a predetermined relay node, among a plurality of relay nodes, receives the preceding data from the source node and the remaining relay nodes, among the plurality of relay nodes, transmit previous data ahead of the preceding data to a destination node; and a second phase performing step of performing a second phase of transmitting subsequent data that follows the preceding data during a second transmission period that follows the first transmission period, wherein, in the second phase, the remaining relay nodes receive the subsequent data from the source node and the predetermined relay node transmits the preceding data to the destination node.

In the first phase performing step, in the first phase, the remaining relay nodes may transmit a precoded interference signal generated by applying a pre-set interference removal scheme to the previous data of the preceding data, to the predetermined relay node.

In the second phase performing step, in the second phase, the predetermined relay node may transmit a precoded interference signal generated by applying the pre-set interference removal scheme to the preceding data, to the remaining relay nodes.

In the second phase performing step, in the second phase, the source node may transmit the precoded interference signal generated by applying the pre-set interference removal scheme to the subsequent data, to the remaining relay nodes.

In the first phase performing step, in the first phase, the predetermined relay node of the relay network may receive the precoded interference signal from the remaining relay nodes and cancel the received precoded interference signal by using the pre-set interference removal scheme.

In the second phase performing step, in the second phase, the remaining relay nodes of the relay network may receive the precoded interference signal from the predetermined relay node and cancel the received precoded interference signal by using the pre-set interference removal scheme.

The relay network may include first, second, and third relay nodes, and the precoded interference signal may be obtained by using precoding matrices VD1 and VD2 that follow an interference alignment scheme in the first phase, wherein the precoding matrices VD1 and VD2 can be expressed by Equation 1 and Equation 2 shown below:

span(H31*VD1)=span(H32*VD2) [Equation 1]

VD1=(H31)⁻¹H32*VD2,

VD2=(H32)⁻¹H31*VD1 [Equation 2]

wherein H31 is a channel from the first relay node to the third relay node, VD1 is a precoding matrix from the second relay node to the destination node, H32 is a channel from the second relay node to the third relay node, and VD2 is a precoding matrix from the second relay node to the destination node.

The precoded interference signal may be obtained by using precoding matrices V2S, V1S, and VD3 that follow the interference alignment scheme in the second phase, and the precoding matrixes V2S, V1S, and VD3 can be expressed by Equation 3 and Equation 4 shown below:

span(H1S*V2S)=span(H13*VD3),

span(H2S*V1S)=span(H23*VD3), [Equation 3]

V2S=(H1S)⁻¹H13*VD3,

V1S=(H2S)⁻¹H23*VD3

VD3=(H13)⁻¹H13*V2S

VD3=(H23)⁻¹H2S*V1S [Equation 4]

wherein H1S is a channel from the source node to the first relay node, V2S is a precoding matrix from the source node to the second relay node, H2S is a channel from the source node to the second relay node, V1S is a precoding matrix from the source node to the first relay node, H13 is a channel from the third relay node to the first relay node, VD3 is a precoding matrix from the third relay node to the destination node, H23 is a channel from the third relay node to the second relay node, and VD3 is a precoding matrix from the third relay node to the destination node.

According to another aspect of the present invention, there is provided a multi-relay transmission method including: a determination step of determining whether a source node has data to be transmitted; a second phase performing step of performing a second phase of transmitting preceding data during a first transmission period equivalent to a transmission period during which unit frames are transmitted, when the source node has data to be transmitted, wherein, in the second phase, remaining relay nodes, excluding a predetermined relay node, among a plurality of relay nodes, receive the preceding data from the source node and the predetermined relay node, among the plurality of relay nodes, transmits previous data ahead of the preceding data to a destination node; and a first phase performing step of performing a first phase of transmitting subsequent data that follows the preceding data during a second transmission period that follows the first transmission period, wherein, in the first phase, the predetermined relay node receives the subsequent data from the source node and the remaining relay nodes transmit the preceding data to the destination node.

In the second phase performing step, in the second phase, the predetermined relay node may transmit a precoded interference signal generated by applying a pre-set interference removal scheme to the previous data of the preceding data, to the remaining relay nodes.

In the first phase performing step, in the first phase, the remaining relay nodes may transmit a precoded interference signal generated by applying the pre-set interference removal scheme to the preceding data, to the predetermined relay node.

In the first phase performing step, in the first phase, the source node may transmit the precoded interference signal generated by applying the pre-set interference removal scheme to the subsequent data, to the remaining relay nodes.

In the second phase performing step, in the second phase, the remaining relay nodes of the relay network may receive the precoded interference signal from the remaining relay nodes and cancel the received precoded interference signal by using the pre-set interference removal scheme.

In the first phase performing step, in the first phase, the predetermined relay node of the relay network may receive the precoded interference signal from the remaining relay nodes and cancel the received precoded interference signal by using the pre-set interference removal scheme.

The relay network may include first, second, and third relay nodes, and the precoded interference signal may be obtained by using precoding matrices VD1 and VD2 that follow an interference alignment scheme in the first phase, wherein the precoding matrices VD1 and VD2 can be expressed by Equation 1 and Equation 2 shown below:

span(H31*VD1)=span(H32*VD2) [Equation 1]

VD1=(H31)⁻¹H32*VD2,

VD2=(H32)⁻¹H31*VD1 [Equation 2]

wherein H31 is a channel from the first relay node to the third relay node, VD1 is a precoding matrix from the second relay node to the destination node, H32 is a channel from the second relay node to the third relay node, and VD2 is a precoding matrix from the second relay node to the destination node.

The precoded interference signal may be obtained by using precoding matrices V2S, V1S, and VD3 that follow the interference alignment scheme in the second phase, and the precoding matrixes V2S, V1S, and VD3 can be expressed by Equation 3 and Equation 4 shown below:

span(H1S*V2S)=span(H13*VD3),

span(H2S*V1S)=span(H23*VD3), [Equation 3]

V2S=(H1S)⁻¹H13*VD3,

V1S=(H2S)⁻¹H23*VD3

VD3=(H13)⁻¹H13*V2S

VD3=(H23)⁻¹H2S*V1S [Equation 4]

wherein H1S is a channel from the source node to the first relay node, V2S is a precoding matrix from the source node to the second relay node, H2S is a channel from the source node to the second relay node, V1S is a precoding matrix from the source node to the first relay node, H13 is a channel from the third relay node to the first relay node, VD3 is a precoding matrix from the third relay node to the destination node, H23 is a channel from the third relay node to the second relay node, and VD3 is a precoding matrix from the third relay node to the destination node.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view showing the configuration of a multi-relay transmission apparatus according to a first embodiment of the present invention.

FIG. 2 is internal block diagrams of a source node, a relay node, and a destination node of the multi-relay transmission apparatus according to the first embodiment of the present invention.

FIG. 3 is a flow chart illustrating a process of a multi-relay transmission method according to a second embodiment of the present invention.

FIG. 4 is a flow chart illustrating a process of a multi-relay transmission method according to a third embodiment of the present invention.

FIG. 5 is a view explaining the concept of a first phase according to each embodiment of the present invention.

FIG. 6 is a view explaining the concept of a second phase according to each embodiment of the present invention.

FIG. 7 is a graph showing the comparison of transfer rates between an embodiment of the present invention and a related art.

### DETAILED DESCRIPTION OF THE INVENTION

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

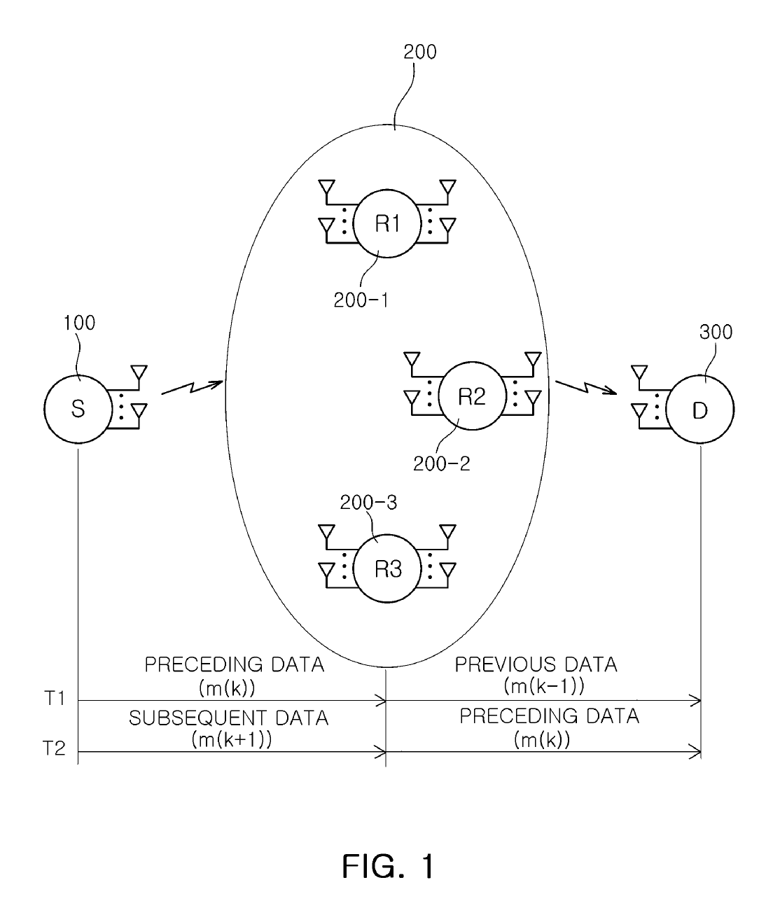

FIG. 1 is a view showing the configuration of a multi-relay transmission apparatus according to a first embodiment of the present invention.

With reference to FIG. 1, a multi-relay transmission apparatus according to a first embodiment of the present invention may include a source node 100, a relay network 200, and a destination node 300.

In FIG. 1, the source node 100 may alternately repeat a first phase in which preceding data is transmitted during a first transmission period T1 equivalent to a transmission period during which unit frames can be transmittable at a time in transmitting data frames, and a second phase in which subsequent data that follows the preceding data is transmitted during a second transmission period T2 that follows the first transmission period T1.

The relay network 200 includes a plurality of relay nodes R1, R2, and R3 receiving data from the source node 100. In the first phase, a predetermined relay node R3, among the plurality of relay nodes R1, R2, and R3, may receive the preceding data from the source node 100, and the remaining relay nodes R1 and R2, among the plurality of relay nodes R1, R2, and R3, may transmit previous data (or former data) ahead of the preceding data to the destination node 300.

Subsequently, in the second phase, in the relay network 200, the remaining relay nodes R1 and R2 may receive subsequent data from the source node 100 and the one predetermined relay node R3 may transmit preceding data ahead of the subsequent data to the destination node 300.

In the first phase, the destination node 300 may receive the previous data ahead of the preceding data from the remaining relay nodes R1 and R2, and in the second phase, the remaining relay nodes R1 and R2 may receive preceding data from the one predetermined relay node R3.

Here, in each embodiment of the present invention, when the preceding data m(k) (m is an integer denoting data order), the subsequent data may be m(k+1) and m(k+2) and the previous data may be m(k−1). Alternatively, when the preceding data is m(k) and m(k+1) (k is an integer denoting data order), the subsequent data may be m(k+2) and the previous data may be m(k−1).

Hereinafter, generation of a precoded interference signal employing an interference removal scheme and interference signal cancellation according to the first embodiment of the present invention will be described.

First, in order to remove interference in the predetermined relay node R3, the remaining relay nodes R1 and R2 may transmit a precoded interference signal generated by applying a pre-set interference removal scheme to the previous data, to the predetermined relay node R3 in the first phase.

Meanwhile, research into an interference channel environment proved that if power of a source node is sufficiently high in an interference channel environment in which a specific number of users exist with an interference channel having a certain size, a channel capacity of the users can reach (or amount to) half of a channel capacity of a channel without interference, and as a corresponding method (or a solution), a paper regarding an interference alignment scheme was presented (or published) by V. R. Cadambe and S. A. Jafar in 2008.

Next, in order to remove interference in the remaining relay nodes R1 and R2, the predetermined relay node R3 may transmit a precoded interference signal generated by applying the pre-set interference removal scheme to the preceding data, to the remaining relay nodes R1 and R2.

Also, in order to remove interference in the remaining relay nodes R1 and R2, the predetermined relay node R3 may transmit a precoded interference signal generated by applying the pre-set interference removal scheme to the subsequent data, to the remaining relay nodes R1 and R2.

Accordingly, the predetermined relay node R3 may receive the precoded interference signal from the remaining relay nodes R1 and R2 in the first phase and cancel the received precoded interference signal by using the pre-set interference removal scheme, and thus, the predetermined relay node R3 can only extract a signal.

Also, the remaining relay nodes R1 and R2 may receive the precoded interference signal from the predetermined relay node R3 in the second phase and cancel the received precoded interference signal by using the pre-set interference removal scheme, and thus, the remaining relay nodes R1 and R2 can only extract a signal.

Here, as the interference removal scheme in each embodiment, a widely known scheme may be employed, examples of which include singular value decomposition, block diagonalization, zero-forcing, and the like.

Meanwhile, examples of internal blocks of the source node 100, the respective relay nodes of the relay network 200, and the destination node 300 will be described.

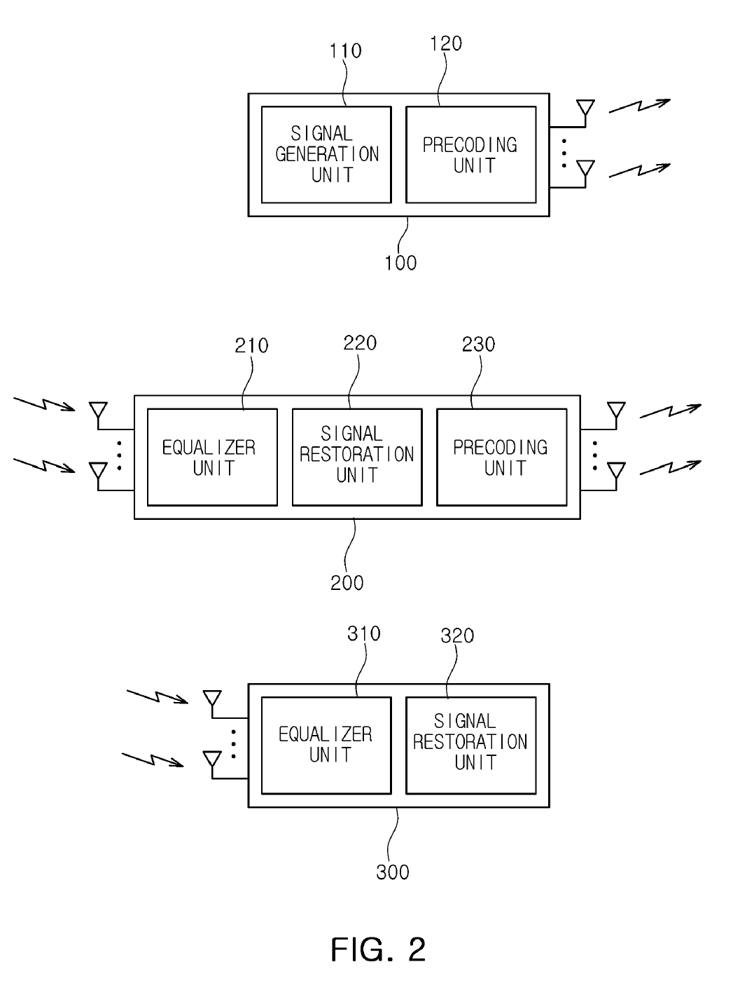

FIG. 2 is internal block diagrams of the source node, the relay nodes, and the destination node of the multi-relay transmission apparatus according to the first embodiment of the present invention.

First, the source node 100 may include a signal generation unit 110 generating the preceding data, the subsequent data, and the previous data, and a precoding unit 120 multiplying data generated by the signal generation unit 110 by a precoding matrix to generate a precoding signal, and transmitting the generated precoding signal through multiple antennas.

Next, each of the relay nodes of the relay network 200 may include an equalizer unit 210 decomposing signals received through multiple antennas through a pre-set interference removal scheme to extract a signal, a signal restoration unit 220 restoring the signal from the equalizer 210, and a precoding unit 230 multiplying the signal restored by the signal restoration unit 220 by a precoding matrix (Vij,i is an arrival node and j is a start node) to generate a precoding signal and transmitting the generated precoding signal to the destination node 300 through the multiple antennas.

The destination node 300 may include an equalizer unit 310 decomposing signals received through multiple antennas through a pre-set interference removal scheme to extract a signal, and a signal restoration unit 320 restoring a signal from the equalizer unit 310.

Here, the interval blocks of the source node 100, the respective relay nodes of the relay network 200, and the destination node 300 illustrated in FIG. 2 are merely provided for the sake of explanation, and the present invention is not limited thereto.

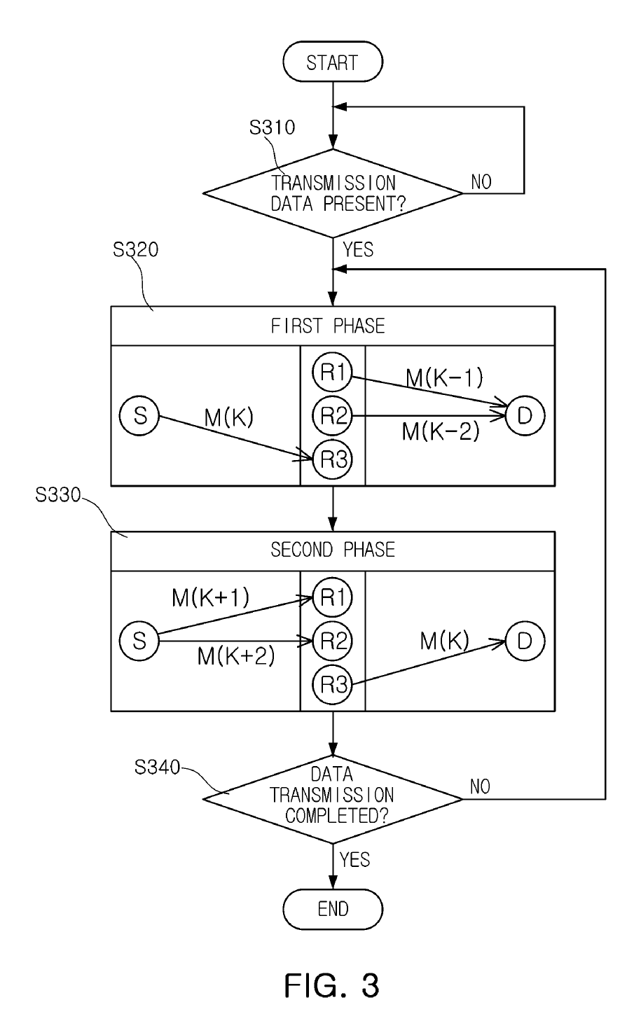

FIG. 3 is a flow chart illustrating a process of a multi-relay transmission method according to a second embodiment of the present invention.

With reference to FIG. 3, the multi-relay transmission method according to the second embodiment of the present invention may include a determination step S310, a first phase performing step S320, and a second phase performing step S330.

First, in the determination step S310, the source node 100 may determine whether it has data to be transmitted.

In the first phase performing step S320, when the source node 100 has data to be transmitted, it may perform a first phase to transmit preceding data during a first transmission period T1, equivalent to a transmission period during which unit frames can be transmittable at a time in transmitting data frames.

Here, in the first phase, the predetermined one predetermined relay node R3 among the plurality of relay nodes R1, R2, and R3 may receive the preceding data from the source node 100, and the remaining relay nodes R1 and R2 among the plurality of relay nodes R1, R2, and R3 may transmit previous data ahead of the preceding data to the destination node 300.

In the second phase performing step S330, a second phase may be performed to transmit subsequent data that follows the preceding data during a second transmission period T2 that follows the first transmission period T1.

Here, in the second phase, the remaining relay nodes R1 and R2 may receive the subsequent data from the source node 100 and the one predetermined relay node R3 may transmit the preceding data to the destination node 300.

Here, when the preceding data m(k) (k is an integer denoting data order), the subsequent data may be m(k+1) and m(k+2) and the previous data may be m(k−1).

In addition, with reference to FIG. 3, after the second phase is performed, step S340 of determining whether the data transmission has been completed may be performed. When the data transmission has not been completed, the process is returned to the first phase, and when the data transmission has been completed, the process is terminated.

Hereinafter, generation of a precoded interference signal employing an interference removal scheme and interference signal cancellation according to the second embodiment of the present invention will be described.

First, in the first phase performing step S320, in the first phase, the remaining relay nodes R1 and R2 may transmit a precoded interference signal generated by applying the pre-set interference removal scheme to the previous data of the preceding data, to the predetermined relay node R3.

Next, in the second phase performing step S330, in the second phase, the predetermined relay node R3 may transmit a precoded interference signal generated by applying the interference removal scheme to the preceding data, to the remaining relay nodes R1 and R2.

Also, in the second phase performing step S330, in the second phase, the predetermined relay node R3 may transmit a precoded interference signal generated by applying the interference removal scheme to the subsequent data of the preceding data, to the remaining relay nodes R1 and R2.

Accordingly, in the first phase performing step, in the first phase, the predetermined relay node R3 of the relay network 200 may receive the precoded interference signal from the remaining relay nodes R1 and R2 and cancel the received precoded interference signal by using the pre-set interference removal scheme, and thus, the predetermined relay node R3 can only extract a signal.

Also, in the second phase performing step, in the second phase, the remaining relay nodes R1 and R2 of the relay network 200 may receive the precoded interference signal from the predetermined relay node R3 and cancel the received precoded interference signal by using the pre-set interference removal scheme, and thus, the remaining relay nodes R1 and R2 can only extract a signal.

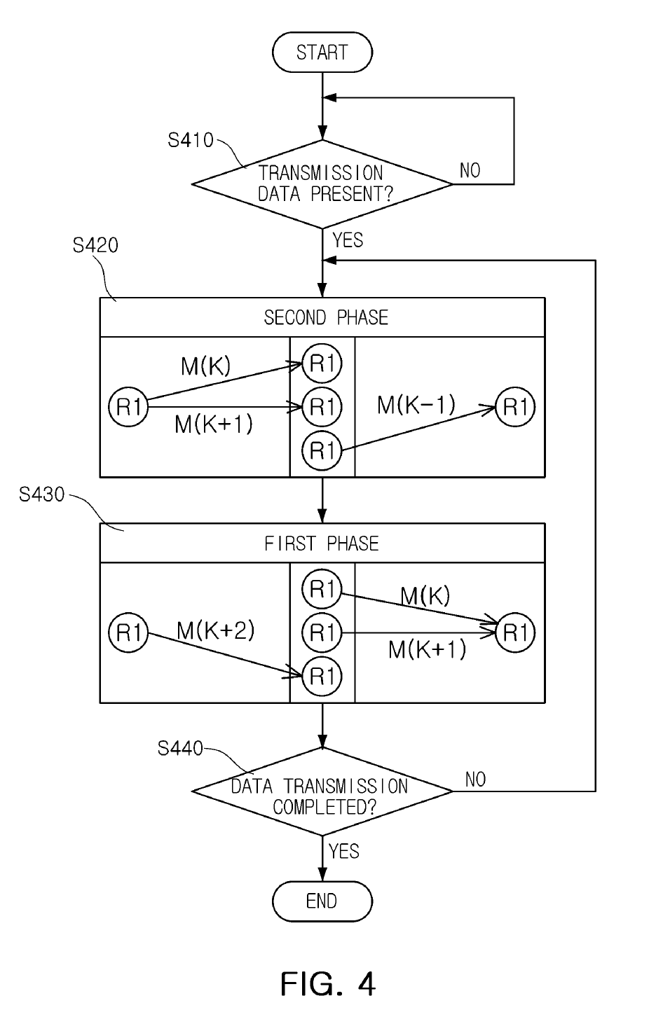

In the foregoing second embodiment of the present invention, the first phase in which the single source node 100 transmits the preceding data to the one predetermined relay node R3 during the first transmission period T1 is first performed, and then, the second phase is performed later, but alternatively, the second phase may be first performed, and the first phase may be then performed. This will be described with reference to FIG. 4.

FIG. 4 is a flow chart illustrating a process of a multi-relay transmission method according to a third embodiment of the present invention.

With reference to FIG. 4, the multi-relay transmission method according to a third embodiment of the present invention may include a determination step S410, a second phase performing step S420, and a first phase performing step S430.

First, in the determination state 5410, the source node 100 may determine whether it has data to be transmitted.

In the second phase performing step S420, when the source node 100 has data to be transmitted, it may perform a second phase to transmit preceding data during a first transmission period T1 equivalent to a transmission period during which unit frames can be transmittable at a time in transmitting data frames.

Here, in the second phase, the remaining relay nodes R1 and R2, excluding the pre-set predetermined relay node R3, among the plurality of relay nodes R1, R2, and R3, may receive the preceding data from the source node 100, and the one predetermined relay node R3, among the plurality of relay nodes R1, R2, and R3, may transmit previous data ahead of the preceding data to the destination node 300.

In the first phase performing step S430, a first phase may be performed to transmit subsequent data that follows the preceding data during a second transmission period T2 that follows the first transmission period T1.

Here, in the first phase, the predetermined relay node R3 may receive the subsequent data from the source node 100 and the remaining relay nodes R1 and R2 may transmit the preceding data to the destination node 300.

Here, when the preceding data is m(k) and m(k+1) (k is integer denoting data order), the subsequent data may be m(k+2) and the previous data may be m(k−1).

In addition, with reference to FIG. 4, after the first phase is performed, step S440 of determining whether the data transmission has been completed may be performed. When the data transmission has not been completed, the process is returned to the second phase, and when the data transmission has been completed, the process is terminated.

Hereinafter, generation of a precoded interference signal employing an interference removal scheme and interference signal cancellation according to the third embodiment of the present invention will be described.

First, in the second phase performing step S420, in the second phase, the predetermined relay node R3 may transmit a precoded interference signal generated by applying the pre-set interference removal scheme to the previous data of the preceding data, to the remaining relay nodes R1 and R2.

Next, in the first phase performing step S430, in the first phase, the remaining relay nodes R1 and R2 may transmit a precoded interference signal generated by applying the interference removal scheme to the preceding data, to the predetermined relay node R3.

Also, in the first phase performing step S430, in the first phase, the predetermined relay node R3 may transmit a precoded interference signal generated by applying the interference removal scheme to the subsequent data of the preceding data, to the remaining relay nodes R1 and R2.

Accordingly, in the second phase performing step, in the second phase, the remaining relay nodes R1 and R2 of the relay network 200 may receive the precoded interference signal from the predetermined relay node R3 and cancel the received precoded interference signal by using the pre-set interference removal scheme, and thus, the predetermined relay node R3 can only extract a signal.

Also, in the first phase performing step, in the first phase, the predetermined relay node R3 of the relay network 200 may receive the precoded interference signal from the remaining relay nodes R1 and R2 and cancel the received precoded interference signal by using the pre-set interference removal scheme, and thus, the remaining relay nodes R1 and R2 can only extract a signal.

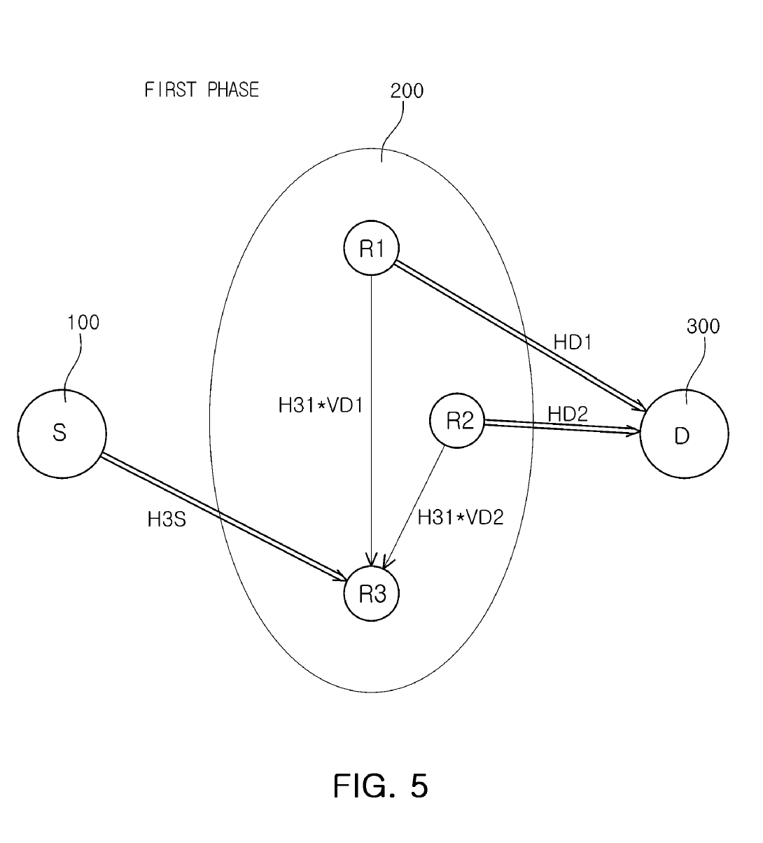

FIG. 5 is a view explaining the concept of a first phase according to each embodiment of the present invention.

With reference to FIG. 5, for example, when the relay network 200 includes the first, the second, and third relay nodes R1, R2, and R3, the precoded interference signal may be obtained by using precoding matrices VD1 and VD2 that follow the interference alignment scheme in the first phase.

The precoding matrices VD1 and VD2 can be obtained by Equation 1 and Equation 2 shown below when interference signals are aligned based on the interference alignment scheme.

span(H31*VD1)=span(H32*VD2) [Equation 1]

VD1=(H31)⁻¹H32*VD2,

VD2=(H32)⁻¹H31*VD1 [Equation 2]

Here, H31 is a channel from the first relay node R1 to the third relay node R3, VD1 is a precoding matrix from the second relay node R2 to the destination node, H32 is a channel from the second relay node R2 to the third relay node R3, and VD2 is a precoding matrix from the second relay node R2 to the destination node.

Also, in an embodiment of the present invention, the interference signal may be expressed by [channel(H)*precoding matrix(V)*data(m)], and here, when a channel and data are determined, each interference signal can be known by obtaining a corresponding precoding matrix.

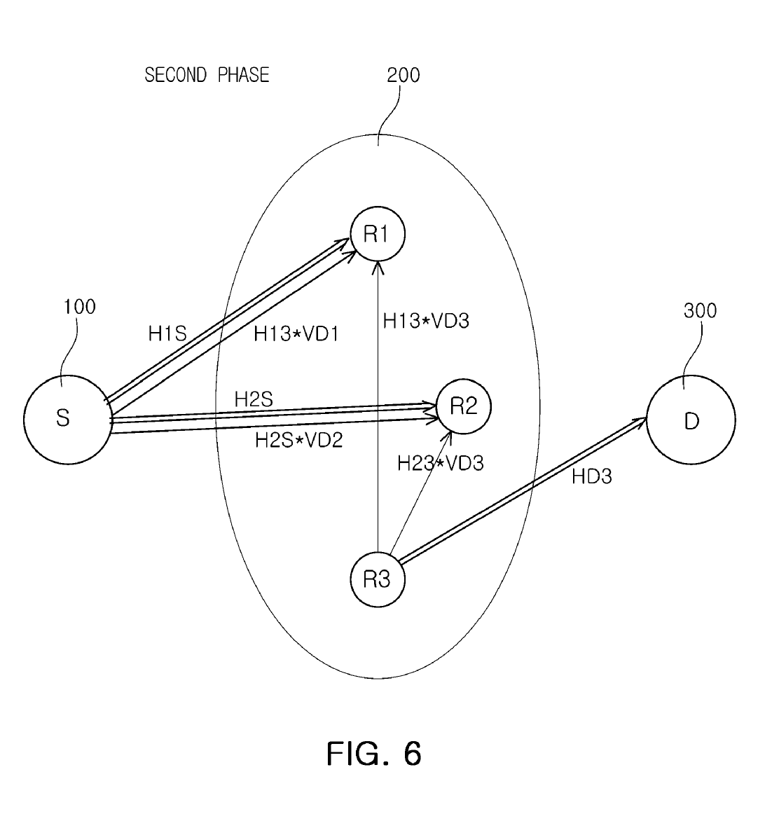

FIG. 6 is a view explaining the concept of a second phase according to each embodiment of the present invention.

With reference to FIG. 6, the precoded interference signal can be obtained by using V2S, V1S, and VD3 that follow the interference alignment scheme in the second phase.

V2S, V1S and VD3 can be obtained by Equation 3 and Equation 4 shown below when the interference signals are aligned based on the interference alignment scheme.

span(H1S*V2S)=span(H13*VD3),

span(H2S*V1S)=span(H23*VD3), [Equation 3]

V2S=(H1S)⁻¹H13*VD3,

V1S=(H2S)⁻¹H23*VD3

VD3=(H13)⁻¹H13*V2S

VD3=(H23)⁻¹H2S*V1S [Equation 4]

Here, H1S is a channel from the source node to the first relay node R1, V2S is a precoding matrix from the source node to the second relay node R2, H2S is a channel from the source node to the second relay node R2, V1S is a precoding matrix from the source node to the first relay node, H13 is a channel from the third relay node R3 to the first relay node R1, VD3 is a precoding matrix from the third relay node R3 to the destination node, H23 is a channel from the third relay node R3 to the second relay node R2, and VD3 is a precoding matrix from the third relay node R3 to the destination node.

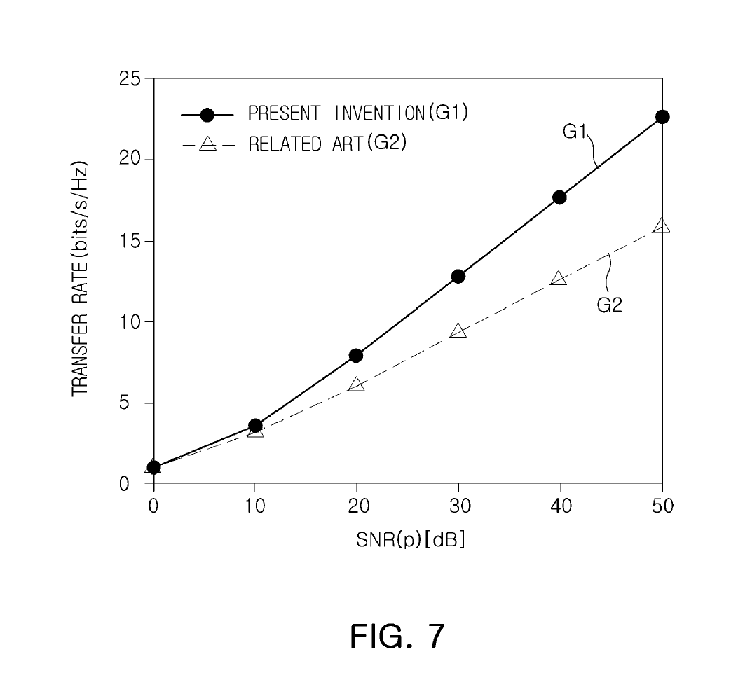

FIG. 7 is a graph showing the comparison of transfer rates between an embodiment of the present invention and a related art.

In FIG. 7, G1 is a graph showing a data transfer rate over signal-to-noise ratio (SNR) of the multi-relay system according to an embodiment of the present invention, and G2 is a graph showing a data transfer rate over signal-to-noise ratio (SNR) of a system using a single relay according to the related art.

With reference to G1 and G2 in FIG. 7, it is noted that the data transfer rate according to the embodiment of the present invention is higher than that of the related art.

In the embodiment of the present invention as described above, based on the interference alignment scheme, when the source node precodes the interference signal such that it is parallel to the space of a reception node that does not wish to receive it, the destination node can perfectly cancel the interference. Here, the signal can be placed in parallel in several dimensions including time, frequency, and space, and such an interference alignment scheme allows for reaching a maximum degree of freedom of the interference channel environment.

As set forth above, according to embodiments of the invention, in a multi-relay system including a single source node, a single destination node, and a plurality of half-duplex relay nodes, when data is transmitted from a base station (source node) to a terminal (destination node) by way of multiple relay nodes, a reduction in the degree of freedom of a data transfer rate is minimized by using the interference alignment scheme and data is continuously transmitted in alternate stages of first and second phases. Thus, a degradation of performance based on the half-duplex relay scheme can be avoided and the reduction in the degree of freedom of the total data transfer rate can be resolved.

While the present invention has been shown and described in connection with the embodiments, it will be apparent to those skilled in the art that modifications and variations can be made without departing from the spirit and scope of the invention as defined by the appended claims.

What is claimed is:

1. A multi-relay transmission apparatus comprising:
a source node repeatedly alternately performing a first phase in which preceding data is transmitted during a first transmission period equivalent to a transmission period during which unit frames are transmitted and a second phase in which subsequent data that follows the preceding data is transmitted during a second transmission period that follows the first transmission period; and
a relay network including a plurality of relay nodes receiving data from the source node, in which, in the first phase, a predetermined relay node, among the plurality of relay nodes, receives the preceding data from the source node and the remaining relay nodes, among the plurality of relay nodes, transmit previous data ahead of the preceding data to a destination node, and in the second phase, the remaining relay nodes receive the subsequent data from the source node and the predetermined relay node transmits the preceding data to the destination node.

2. The multi-relay transmission apparatus of claim 1, wherein, in the first phase, the remaining relay nodes transmit a precoded interference signal generated by applying a pre-set interference removal scheme to the previous data of the preceding data, to the predetermined relay node.

3. The multi-relay transmission apparatus of claim 2, wherein, in the second phase, the predetermined relay node transmits a precoded interference signal generated by applying the pre-set interference removal scheme to the preceding data, to the remaining relay nodes.

4. The multi-relay transmission apparatus of claim 3, wherein, in the second phase, the source node transmits the precoded interference signal generated by applying the pre-set interference removal scheme to the subsequent data, to the remaining relay nodes.

5. The multi-relay transmission apparatus of claim 4, wherein, in the first phase, the predetermined relay node receives the precoded interference signal from the remaining relay nodes and cancels the received precoded interference signal by using the pre-set interference removal scheme.

6. The multi-relay transmission apparatus of claim 5, wherein, in the second phase, the remaining relay nodes receive the precoded interference signal from the predetermined relay node and cancel the received precoded interference signal by using the pre-set interference removal scheme.

7. The multi-relay transmission apparatus of claim 4, wherein the relay network comprises first, second, and third relay nodes, and the precoded interference signal is obtained by using precoding matrices VD1 and VD2 that follow an interference alignment scheme in the first phase, wherein the precoding matrices VD1 and VD2 are expressed by Equation 1 and Equation 2 shown below:
span(H31*VD1)=span(H32*VD2) [Equation 1]
VD1=(H31)⁻¹H32*VD2,
VD2=(H32)⁻¹H31*VD1 [Equation 2]
wherein H31 is a channel from the first relay node to the third relay node, VD1 is a precoding matrix from the second relay node to the destination node, H32 is a channel from the second relay node to the third relay node, and VD2 is a precoding matrix from the second relay node to the destination node.

8. The multi-relay transmission apparatus of claim 7, wherein the precoded interference signal is obtained by using precoding matrices V2S, V1S, and VD3 that follow the interference alignment scheme in the second phase, and the precoding matrixes V2S, V1S, and VD3 are expressed by Equation 3 and Equation 4 shown below:
span(H1S*V2S)=span(H13*VD3),
span(H2S*V1S)=span(H23*VD3), [Equation 3]
V2S=(H1S)⁻¹H13*VD3,
V1S=(H2S)⁻¹H23*VD3
VD3=(H13)⁻¹H13*V2S
VD3=(H23)⁻¹H2S*V1S [Equation 4]
wherein H1S is a channel from the source node to the first relay node, V2S is a precoding matrix from the source node to the second relay node, H2S is a channel from the source node to the second relay node, V1S is a precoding matrix from the source node to the first relay node, H13 is a channel from the third relay node to the first relay node, VD3 is a precoding matrix from the third relay node to the destination node, H23 is a channel from the third relay node to the second relay node, and VD3 is a precoding matrix from the third relay node to the destination node.

9. A multi-relay transmission method comprising:
a determination operation of determining whether a source node has data to be transmitted;
a first phase performing operation of performing a first phase of transmitting preceding data during a first transmission period equivalent to a transmission period during which unit frames are transmitted, when the source node has data to be transmitted, wherein, in the first phase, a predetermined relay node, among a plurality of relay nodes, receives the preceding data from the source node and the remaining relay nodes, among the plurality of relay nodes, transmit previous data ahead of the preceding data to a destination node; and
a second phase performing operation of performing a second phase of transmitting subsequent data that follows the preceding data during a second transmission period that follows the first transmission period, wherein, in the second phase, the remaining relay nodes receive the subsequent data from the source node and the predetermined relay node transmits the preceding data to the destination node.

10. The method of claim 9, wherein, in the first phase performing operation, in the first phase, the remaining relay nodes transmit a precoded interference signal generated by applying a pre-set interference removal scheme to the previous data of the preceding data, to the predetermined relay node.

11. The method of claim 10, wherein, in the second phase performing operation, in the second phase, the predetermined relay node transmits a precoded interference signal generated by applying the pre-set interference removal scheme to the preceding data, to the remaining relay nodes.

12. The method of claim 11, wherein, in the second phase performing operation, in the second phase, the source node transmits the precoded interference signal generated by applying the pre-set interference removal scheme to the subsequent data, to the remaining relay nodes.

13. The method of claim 12, wherein, in the first phase performing operation, in the first phase, the predetermined relay node of the relay network receives the precoded interference signal from the remaining relay nodes and cancel the received precoded interference signal by using the pre-set interference removal scheme.

14. The method of claim 13, wherein, in the second phase performing operation, in the second phase, the remaining relay nodes of the relay network receive the precoded interference signal from the predetermined relay node and cancel the received precoded interference signal by using the pre-set interference removal scheme.

15. The method of claim 12, wherein the relay network comprises first, second, and third relay nodes, and the precoded interference signal is obtained by using precoding matrices VD1 and VD2 that follow an interference alignment scheme in the first phase, wherein the precoding matrices VD1 and VD2 are expressed by Equation 1 and Equation 2 shown below:
span(H31*VD1)=span(H32*VD2) [Equation 1]
VD1=(H31)⁻¹H32*VD2,
VD2=(H32)⁻¹H31*VD1 [Equation 2]
wherein H31 is a channel from the first relay node to the third relay node, VD1 is a precoding matrix from the second relay node to the destination node, H32 is a channel from the second relay node to the third relay node, and VD2 is a precoding matrix from the second relay node to the destination node.

16. The method of claim 15, wherein the precoded interference signal is obtained by using precoding matrices V2S, V1S, and VD3 that follow the interference alignment scheme in the second phase, and the precoding matrixes V2S, V1S, and VD3 are expressed by Equation 3 and Equation 4 shown below:
span(H1S*V2S)=span(H13*VD3),
span(H2S*V1S)=span(H23*VD3), [Equation 3]
V2S=(H1S)⁻¹H13*VD3,
V1S=(H2S)⁻¹H23*VD3
VD3=(H13)⁻¹H13*V2S
VD3=(H23)⁻¹H2S*V1S [Equation 4]
wherein H1S is a channel from the source node to the first relay node, V2S is a precoding matrix from the source node to the second relay node, H2S is a channel from the source node to the second relay node, V1S is a precoding matrix from the source node to the first relay node, H13 is a channel from the third relay node to the first relay node, VD3 is a precoding matrix from the third relay node to the destination node, H23 is a channel from the third relay node to the second relay node, and VD3 is a precoding matrix from the third relay node to the destination node.

17. A multi-relay transmission method comprising:
a determination operation of determining whether a source node has data to be transmitted;
a second phase performing operation of performing a second phase of transmitting preceding data during a first transmission period equivalent to a transmission period during which unit frames are transmitted, when the source node has data to be transmitted, wherein, in the second phase, remaining relay nodes, excluding a predetermined relay node, among a plurality of relay nodes, receive the preceding data from the source node and the predetermined relay node, among the plurality of relay nodes, transmits previous data ahead of the preceding data to a destination node; and
a first phase performing operation of performing a first phase of transmitting subsequent data that follows the preceding data during a second transmission period that follows the first transmission period, wherein, in the first phase, the predetermined relay node receives the subsequent data from the source node and the remaining relay nodes transmit the preceding data to the destination node.

18. The method of claim 17, wherein, in the second phase performing operation, in the second phase, the predetermined relay node transmits a precoded interference signal generated by applying a pre-set interference removal scheme to the previous data of the preceding data, to the remaining relay nodes.

19. The method of claim 18, wherein, in the first phase performing operation, in the first phase, the remaining relay nodes transmit a precoded interference signal generated by applying the pre-set interference removal scheme to the preceding data, to the predetermined relay node.

20. The method of claim 19, wherein, in the first phase performing operation, in the first phase, the source node transmits the precoded interference signal generated by applying the pre-set interference removal scheme to the subsequent data, to the remaining relay nodes.

21. The method of claim 20, wherein, in the second phase performing operation, in the second phase, the remaining relay nodes of the relay network receive the precoded interference signal from the remaining relay nodes and cancel the received precoded interference signal by using the pre-set interference removal scheme.

22. The method of claim 21, wherein, in the first phase performing operation, in the first phase, the predetermined relay node of the relay network receives the precoded interference signal from the remaining relay nodes and cancel the received precoded interference signal by using the pre-set interference removal scheme.

23. The method of claim 20, wherein the relay network comprises first, second, and third relay nodes, and the precoded interference signal is obtained by using precoding matrices VD1 and VD2 that follow an interference alignment scheme in the first phase, wherein the precoding matrices VD1 and VD2 are expressed by Equation 1 and Equation 2 shown below:
span(H31*VD1)=span(H32*VD2) [Equation 1]
VD1=(H31)⁻¹H32*VD2,
VD2=(H32)⁻¹H31*VD1 [Equation 2]
wherein H31 is a channel from the first relay node to the third relay node, VD1 is a precoding matrix from the second relay node to the destination node, H32 is a channel from the second relay node to the third relay node, and VD2 is a precoding matrix from the second relay node to the destination node.

24. The method of claim 23, wherein the precoded interference signal is obtained by using precoding matrices V2S, V1S, and VD3 that follow the interference alignment scheme in the second phase, and the precoding matrixes V2S, V1S, and VD3 are expressed by Equation 3 and Equation 4 shown below:
span(H1S*V2S)=span(H13*VD3),
span(H2S*V1S)=span(H23*VD3), [Equation 3]
V2S=(H1S)⁻¹H13*VD3,
V1S=(H2S)⁻¹H23*VD3
VD3=(H13)⁻¹H13*V2S
VD3=(H23)⁻¹H2S*V1S [Equation 4]
wherein H1S is a channel from the source node to the first relay node, V2S is a precoding matrix from the source node to the second relay node, H2S is a channel from the source node to the second relay node, V1S is a precoding matrix from the source node to the first relay node, H13 is a channel from the third relay node to the first relay node, VD3 is a precoding matrix from the third relay node to the destination node, H23 is a channel from the third relay node to the second relay node, and VD3 is a precoding matrix from the third relay node to the destination node.
